(19) United States
(12) Patent Application Publication
(10) Pub. No.: US 2024/0393550 A1
(43) Pub. Date: Nov. 28, 2024

(54) FIBER OPTIC ATTACHMENT APPARATUS AND ATTACHING AN OPTICAL FIBER TO AN INTEGRATED PHOTONIC CHIP

(71) Applicant: Government of the United States of America, as represented by the Secretary of Commerce, Gaithersburg, MD (US)

(72) Inventor: Jeffrey Taylor Chiles, Louisville, CO (US)

(21) Appl. No.: 18/674,053

(22) Filed: May 24, 2024

Related U.S. Application Data
(60) Provisional application No. 63/468,847, filed on May 25, 2023.

(51) Int. Cl. G02B 6/42

(52) U.S. Cl. CPC G02B 6/4239

(57) ABSTRACT

A fiber optic attachment apparatus includes a chip; a harbor on the chip; an optical fiber; and an adhesive, wherein the optical fiber is attached to the chip in the harbor by the adhesive.

### RELATED APPLICATIONS

This application claims the benefit of U.S. Provisional Patent Application Ser. No. 63/468,847 (filed May 25, 2023), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to coupling technology, and more particularly to coupling an optical fiber to a photonic chip.

### BACKGROUND

Optical fibers attach to integrated photonic chips and represent a critical interface in modern photonics technology, enabling efficient and high-speed communication and information processing systems. Integrated photonic chips, also known as photonic integrated circuits (PICs), are miniaturized platforms that consolidate various optical components such as waveguides, modulators, detectors, and filters onto a single chip. These chips offer significant advantages over traditional bulk optics, including reduced size, weight, and power consumption, as well as enhanced performance and scalability. However, to fully exploit the capabilities of PICs, a seamless connection to external optical fibers is desirable.

The interface between optical fibers and integrated photonic chips conventionally involves alignment and coupling mechanisms to efficiently transfer light between the two mediums. Various techniques such as grating couplers, spot-size converters, and fiber tapers are used in the art to minimize losses and alignment complexities. These conventional interfaces play a pivotal role in numerous applications, including telecommunications, data communication, sensing, and optical interconnects for high-performance computing.

### SUMMARY OF INVENTION

Problems with conventional technology for attaching an optical fiber to an integrated photonic chip include errors in alignment, contamination, mechanical stress, and environmental factors. Regarding alignment, the fiber and the chip must be aligned precisely to achieve good optical coupling. This can be difficult to do, especially with small fibers or chips, as even a small misalignment can result in significant loss of light. Regarding contamination, the fiber optic and the chip must be clean and free of contaminants to achieve good optical coupling. This can be difficult to ensure, especially if the fiber or chip is being handled in a dusty or humid environment, as contaminants can interfere with the light signal. Regarding mechanical stress, the fiber and the chip must be attached in a way that does not put too much mechanical stress on either component. This can be difficult to do, especially if the fiber or chip is small or fragile, as too much stress can cause the fiber to break or the chip to crack. Regarding environmental factors, the fiber and the chip must be protected from environmental factors such as heat, humidity, and vibration. This can be difficult to do, especially if the fiber or chip is being used in a harsh environment, as these factors can cause the fiber to degrade or the chip to malfunction. Various conventional technologies suffer from these problems that can occur when attaching an optical fiber to an integrated photonic chip. Advantageously, a process for attaching an optical fiber to an integrated photonic chip described herein overcomes these limitations of conventional technology and avoid such problems and associated issues to achieve a successful connection between a fiber optic and a photonic chip.

According to one aspect of the invention, a fiber optic attachment apparatus includes a chip; a harbor on the chip; an optical fiber; and an adhesive, wherein the optical fiber is attached to the chip in the harbor by the adhesive.

Optionally, the harbor comprises a pair of docks protruding from an edge of the chip and spaced from each other, and wherein the optical fiber is disposed between the docks and secured therebetween by the adhesive.

Optionally, the docks include corrugated inner surfaces.

Optionally, the harbor has a width of between 50 microns to 2 centimeters.

Optionally, the harbor comprises docks protruding from the edge of the chip by 50 microns to 3 millimeters.

Optionally, the docks each have a plurality of fins protruding from the edge of the dock by a length of between 1 micron to 30 microns.

Optionally, the optical fiber has a total width of 125 microns.

Optionally, the optical fiber incorporates a lensed-tip with a final mode-field diameter of 3 microns.

Optionally, the optical fiber operates in single-mode in the 1.3 to 1.6 micron wavelength band.

Optionally, the adhesive is a mechanical-grade two-component epoxy putty capable of withstanding continuous operation at 200 degrees Celsius or more.

Optionally, the optical fiber is aligned with the waveguide on the chip and the adhesive is disposed between the optical fiber and the waveguide.

Optionally, the optical fiber is permanently attached to the chip by the adhesive.

Optionally, the fiber optic attachment apparatus provides an optical fiber aligned and attached to a photonic system on a chip in a monolithic structure.

Optionally, the fiber optic attachment apparatus provides fine alignment positioning of the optical fiber with respect to the waveguide on the chip.

According to another aspect, a method for attaching an optical fiber to an integrated photonic chip, includes providing an optical fiber; providing an integrated photonic chip comprising a harbor; aligning the optical fiber with the integrated photonic chip; and attaching the optical fiber to the integrated photonic chip.

Optionally, the optical fiber is a single-mode optical fiber.

Optionally, the optical fiber is attached to the integrated photonic chip by a mechanical-grade two-component epoxy putty capable of withstanding continuous operation at 200 degrees Celsius or more.

Optionally, the optical fiber is aligned with the waveguide on the integrated photonic chip and the adhesive is disposed between the optical fiber and the waveguide.

Optionally, the optical fiber is permanently attached to the integrated photonic chip by the adhesive.

Optionally, the method provides an optical fiber aligned and attached to a photonic system on the integrated photonic chip in a monolithic structure.

The foregoing and other features of the invention are hereinafter described in greater detail with reference to the accompanying drawings.

### BRIEF DESCRIPTION OF THE DRAWINGS

FIG. 1 shows, according to some embodiments, a fiber optic attachment apparatus 100.

FIG. 2 shows, according to some embodiments, an arrangement of elements of a harbor.

FIG. 3 shows, according to some embodiments, a cross-sectional view of a harbor

### DETAILED DESCRIPTION

Described herein is a process for attaching an optical fiber to an integrated photonic chip. The process can include micromachining harbors into an outer edge of the chip; actively aligning an optical fiber to an on-chip waveguide; and attaching the fiber optic to the chip. Attachment can occur via an adhesive such as epoxy. No sub-mounts or fiber carriers are required, such that the process provides a simpler and lower-profile package than conventional technology.

In an embodiment, fiber optic attachment apparatus 110 attaches optical fiber 103 to substrate 101 (also referred to herein as a chip) with alignment accuracy to a plurality of optical elements disposed on chip 101. Chip 101 receives adhesive 105 for direct attachment of optical fiber 103 to mechanical structure 109 (referred to as a harbor) that provides mechanical support for optical fiber 103 and minimizes the quantity and thickness of adhesive to firmly bond the fiber to the harbor.

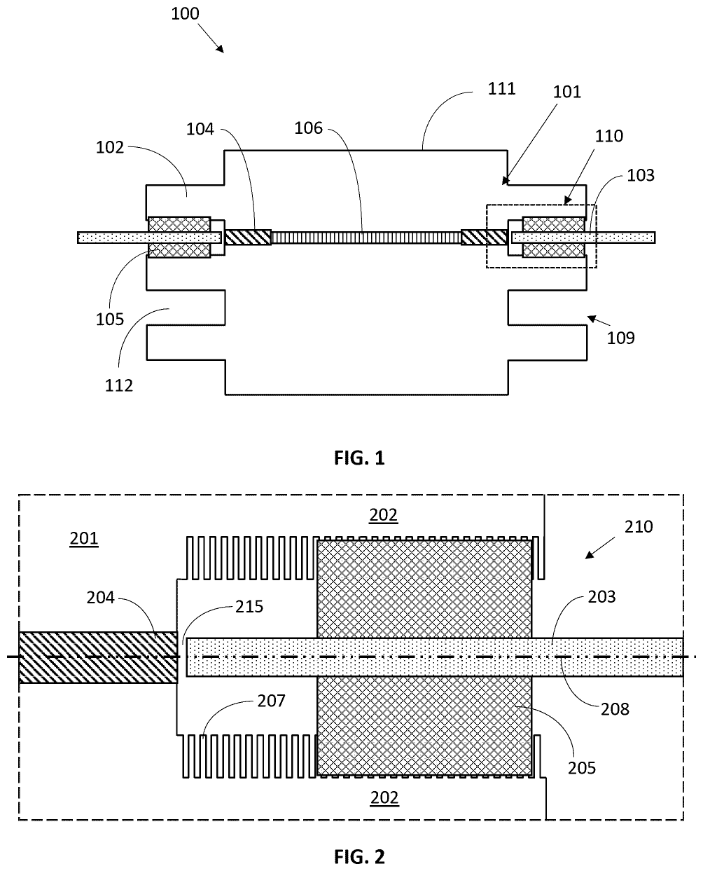

FIG. 1 shows fiber optic attachment apparatus 110 including chip 101 including harbors 109, wherein each harbor can include two extended portions of the substrate referred to as docks 102 that extend outward from a main body 111 of chip 101 and are separated from each other by a gap 112 wide enough for the optical fiber 103 to enter without mechanical impediment. Accordingly, fiber optic attachment apparatus 110 aligns optical fiber 103 to photonic elements on chip 101. The optical elements can include a mode-field adapter 104 and/or integrated photonic system 106. A mode-field adapter 104 allows a guided optical mode to transition from one size or distribution pattern to another one, e.g., a nanophotonic guided mode of sub-micron mode area to another one closely matching a single-mode optical fiber. The functionality of integrated photonic system 106 is independent of the operation of fiber optic attachment apparatus 201.

In an embodiment, optical fiber 103 is disposed in harbor 109, such that the optical mode field of the fiber is coarsely aligned with that of the mode-field adapter 104 or the nearest interface of the integrated photonic system. Adhesive 105 is disposed at harbor 109 distal to the body of the chip and allowed to coat the fiber and dock 102, e.g., by capillary forces, filling an area indicated by the hatched area of adhesive 105. The fiber is then aligned to the photonic elements on the chip to maximize optical transmission into or out of the chip. The adhesive can then be cured, e.g., by exposure to ultraviolet light, exposure to elevated temperatures, and/or by chemical reaction. The position of the fiber or chip position can be adjusted during the curing process to maintain sufficient alignment accuracy. Once the adhesive is cured, fiber optic attachment apparatus 110 provides a mechanical support structure by which the initial alignment of the optical fiber to the photonic system can be maintained.

FIG. 2 shows a close-up view of the attachment apparatus at 210 as indicated by the dashed box in FIG. 1, reproduced in FIG. 2 and bounding the illustration there. The optical fiber 203 can be equidistant from the edges of each dock 202. The mode-field adapter 204, optionally disposed on chip 201, can be separated by a small gap 215 between it and the tip of the optical fiber, or can also be in direct contact. A plurality of fins 207 can be disposed on the long interior edges of each dock 202. The fins improve adhesion and stability of the adhesive to bond the optical fiber to the harbor.

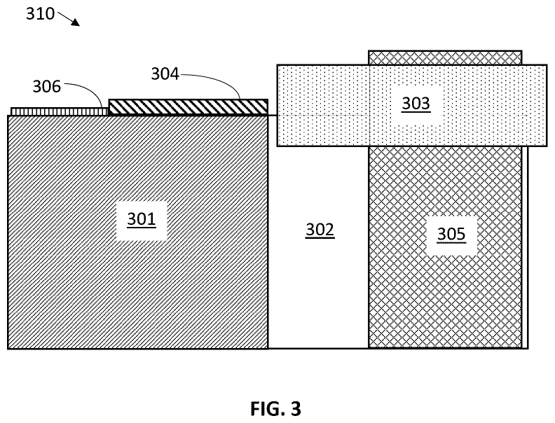

A cross-section along line 208 of the harbor in FIG. 2 is shown in FIG. 3. FIG. 3 shows a vertical position of optical fiber 303, wherein optical fiber 303 is centered with respect to the center of the mode-field adapter 304 at the edge of the chip. The vertical profile of the adhesive 305 is shown. It is contemplated that capillary forces can pull adhesive 305 over the optical fiber 303, as well as below, to the lowest surface of the chip 301.

Referring again to FIG. 1, for illustration, but equally applicable to FIGS. 2 and 3, the chip 101 can include of a variety of materials such as silicon, silicon dioxide, gallium arsenide, indium phosphide, sapphire, or a variety of alloys of such materials, with a thickness between 100 microns to 2 mm. It can include from 1 to 100 harbors 109 distributed uniformly or nonuniformly along the perimeter. The gap 112 between docks 102, where the optical fiber is to be attached, can range from 125 microns to 500 microns. The harbors 109 each comprise two docks 102 protruding from the edge of the chip by 50 microns to 3 millimeters, and can have a width between 50 microns to 2 centimeters. For chips with a small number of harbors 109 (on the order of about 1 to 15) on a given side, the width can be between 1 millimeter to 2 centimeters, e.g. Finally, the fins 107 can have a spacing between 1 micron to 30 microns, and can protrude from the edge of the dock by a length between 1 micron to 30 microns. The chip can include silicon and incorporate a variety of on-chip integrated optical devices designed for operation in the infrared telecommunications band between 1.3 to 1.6 micron wavelength. The optical fiber to be attached to the chip can have a total width of 125 microns, incorporate a lensed-tip with a final mode-field diameter of 3 microns, and operate in single-mode in the 1.3 to 1.6 micron wavelength band.

The adhesive can be, e.g., a mechanical-grade two-component epoxy putty capable of withstanding continuous operation at 200 degrees Celsius or more. The fiber can be aligned, and the epoxy disposed at a temperature of 70 degrees Celsius, allowing the epoxy to cure, after which it is permanently attached to the chip. The optical transmission through a chip packaged in this way may degrade only by 1 dB when cooling the chip to room temperature 20 degrees Celsius after the epoxy was cured, wherein thermal contraction-induced misalignment was addressed by strong mechanical coupling between the chip, harbor, and fiber.

Fiber optic attachment apparatus 110 is superior to conventional technology because fiber optic attachment apparatus 110 provides an optical fiber aligned and attached to a photonic system on a chip in a monolithic structure and providing fine alignment positioning. Fiber optic attachment apparatus 110 need not involve sub-mounts, adapters, or other components that are conventionally involved in fiber-to-chip alignment and that can be detrimental in terms of system complexity and reliability.

Some conventional attachment technology involve V-grooves or channels etched into the photonic chip for fibers to be passively aligned to the waveguide by mechanical constriction, but such can have poor performance in coupling efficiency due to lack of precise fiber core geometry and placement of the constricting features with respect to the waveguide. In contrast, active alignment strategies offer acceptable coupling efficiency and require a sub-mount or carrier to attach the fiber to the chip, but thermal effects cause drift of the fiber with respect to the chip, and drift can exceed the misalignment budget. Fiber optic attachment apparatus 110 overcomes these limitations of conventional technology because the fiber is directly attached to the chip, wherein the fiber does not have freedom to move under external stress or temperature-induced expansion or contraction. Further, the harbor is relatively long and large, and the fiber cannot bend or twist on the chip. Corrugations (fins) along the harbor increases adhesion of epoxy and reduces delamination occurrence.

Fiber optic attachment apparatus 110 can be made of various elements and components that are microfabricated and can be various sizes. Elements of fiber optic attachment apparatus 110 can be made of a material that is physically or chemically resilient in an environment in which fiber optic attachment apparatus 110 is disposed. Exemplary materials include a metal, ceramic, thermoplastic, glass, semiconductor, and the like. The elements of fiber optic attachment apparatus 110 can be made of the same or different material and can be monolithic in a single physical body or can be separate members that are physically joined.

Fiber optic attachment apparatus 110 can be made in various ways. It should be appreciated that fiber optic attachment apparatus 110 includes a number of optical, electrical, or mechanical components, wherein such components can be interconnected and placed in communication (e.g., optical communication, electrical communication, mechanical communication, and the like) by physical, chemical, optical, or free-space interconnects. The components can be disposed on mounts that can be disposed on a bulkhead for alignment or physical compartmentalization. As a result, fiber optic attachment apparatus 110 can be disposed in a terrestrial environment or space environment. Elements of fiber optic attachment apparatus 110 can be formed from silicon, silicon nitride, and the like although other suitable materials, such ceramic, glass, or metal can be used. According to an embodiment, the elements of fiber optic attachment apparatus 110 are formed using 3D printing although the elements of fiber optic attachment apparatus 110 can be formed using other methods, such as injection molding or machining a stock material such as block of material that is subjected to removal of material such as by cutting, laser oblation, and the like. Accordingly, fiber optic attachment apparatus 110 can be made by additive or subtractive manufacturing. In an embodiment, elements of fiber optic attachment apparatus 110 are selectively etched to remove various different materials using different etchants and photolithographic masks and procedures. The various layers thus formed can be subjected to joining by bonding to form fiber optic attachment apparatus 110.

Fiber optic attachment apparatus 110 has numerous advantageous and unexpected benefits and uses. Once the fiber optic is attached to the chip, it can be used to transmit light signals. The fiber optic can be used to connect the chip to other devices, such as a laser or a detector. The fiber optic can also be used to send light signals over long distances.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A fiber optic attachment apparatus comprising:
a chip;
a harbor on the chip;
an optical fiber; and
an adhesive, wherein the optical fiber is attached to the chip in the harbor by the adhesive.

2. The fiber optic attachment apparatus of claim 1, wherein the harbor comprises a pair of docks protruding from an edge of the chip and spaced from each other, and wherein the optical fiber is disposed between the docks and secured therebetween by the adhesive.

3. The fiber optic attachment apparatus of claim 2, wherein the docks include corrugated inner surfaces.

4. The fiber optic attachment apparatus of claim 1, wherein the harbor has a width of between 50 microns to 2 centimeters.

5. The fiber optic attachment apparatus of claim 1, wherein the harbor comprises docks protruding from the edge of the chip by 50 microns to 3 millimeters.

6. The fiber optic attachment apparatus of claim 1, wherein the docks each have a plurality of fins protruding from the edge of the dock by a length of between 1 micron to 30 microns.

7. The fiber optic attachment apparatus of claim 1, wherein the optical fiber has a total width of 125 microns.

8. The fiber optic attachment apparatus of claim 1, wherein the optical fiber incorporates a lensed-tip with a final mode-field diameter of 3 microns.

9. The fiber optic attachment apparatus of claim 1, wherein the optical fiber operates in single-mode in the 1.3 to 1.6 micron wavelength band.

10. The fiber optic attachment apparatus of claim 1, wherein the adhesive is a mechanical-grade two-component epoxy putty capable of withstanding continuous operation at 200 degrees Celsius or more.

11. The fiber optic attachment apparatus of claim 1, wherein the optical fiber is aligned with the waveguide on the chip and the adhesive is disposed between the optical fiber and the waveguide.

12. The fiber optic attachment apparatus of claim 1, wherein the optical fiber is permanently attached to the chip by the adhesive.

13. The fiber optic attachment apparatus of claim 1, wherein the fiber optic attachment apparatus provides an optical fiber aligned and attached to a photonic system on a chip in a monolithic structure.

14. The fiber optic attachment apparatus of claim 1, wherein the fiber optic attachment apparatus provides fine alignment positioning of the optical fiber with respect to the waveguide on the chip.

15. A method for attaching an optical fiber to an integrated photonic chip, the method comprising:
providing an optical fiber;
providing an integrated photonic chip comprising a harbor;
aligning the optical fiber with the integrated photonic chip; and
attaching the optical fiber to the integrated photonic chip.

16. The method of claim 15, wherein the optical fiber is a single-mode optical fiber.

17. The method of claim 15, wherein the optical fiber is attached to the integrated photonic chip by a mechanical-grade two-component epoxy putty capable of withstanding continuous operation at 200 degrees Celsius or more.

18. The method of claim 15, wherein the optical fiber is aligned with the waveguide on the integrated photonic chip and the adhesive is disposed between the optical fiber and the waveguide.

19. The method of claim 15, wherein the optical fiber is permanently attached to the integrated photonic chip by the adhesive.

20. The method of claim 15, wherein the method provides an optical fiber aligned and attached to a photonic system on the integrated photonic chip in a monolithic structure.
